(19) United States
(12) Patent Application Publication
(10) Pub. No.: US 2001/0044384 A1
(43) Pub. Date: Nov. 22, 2001

(54) Method of preventing premature fruit drop from apple trees

(76) Inventors: Charles Harry Baldwin JR., Port Ludlow, WA (US); Tibor G. Szoke, Chamelet (FR)

Correspondence Address: Mary Katherine Baumeister, BURNS, DOANE, SWECKER & MATHIS, L.L.P., P.O. Box 1404, Alexandria, VA, 22313-1404, US

(21) Appl. No.: 09/771,698

(22) Filed: Jan. 30, 2001

Related U.S. Application Data
(63) Continuation of application No. PCT/EP99/05742, filed on Jul. 27, 1999.
(60) Provisional application No. 60/094,665, filed on Jul. 30, 1998.

(51) Int. Cl. A01N 37/18

(52) U.S. Cl. 504/334

(57) ABSTRACT

A method of preventing fruit drop in apple trees by application of cyclanilide to the tree. A method of improving the quality of apples.

### CROSS-REFERENCE TO RELATED APPLICATIONS

This is a continuation of International Application No. PCT/EP99/05742, filed Jul. 27, 1999, designating the United States, incorporated by reference herein in its entirety and relied upon, and claiming the priority of U.S. Provisional Application No. 60/094,665, filed Jul. 30, 1998.

The present invention provides a new method of preventing fruit drop from apples trees and a method of improving apple quality.

A known problem in the production of apples is the premature loss of fruit from trees due to maturation of fruit before the fruit can be harvested. Fruit that matures more rapidly than the majority of fruit on a tree has a tendency to drop off the tree, thus lowering the yield of fruit per tree. This problem has substantial adverse implications to apple growers since the growers wish to harvest apples generally one time per growing season. To harvest fruit at multiple intervals to prevent loss of prematurely dropped fruit during the ripening period adds to the cost of production and is undesirable. Thus there exists a need for controlling premature fruit drop in apple trees.

An object of the present invention is to provide a method of preventing fruit drop in apple trees.

Another object of the present invention is to provide a method of improving the quality of apples on apple trees and/or when harvested.

These objects are met in whole or in part by the present invention.

The present invention provides a method of preventing premature fruit loss from an apple tree, e.g. a tree in need of prevention of fruit drop, which method comprises applying a composition comprising cyclanilide or an agriculturally acceptable salt thereof to the tree.

Cyclanilide is also known as 1-(2,4-dichloroanilinocarbonyl)cyclopropane carboxylic acid. It and salts thereof may be prepared by methods described in U.S. Pat. No. 4,736,056 or other references known to the skilled addressee.

In a preferred embodiment, cyclanilide is applied to the tree by spraying a liquid composition on the leaves of the tree and/or on the fruit. The compositions according to the instant invention generally comprise from about 0.5 to about 95% cyclanilide. The remainder of the composition up to 100% generally comprises a carrier as well as various additives such as those hereafter indicated.

The composition also may comprise a surfactant, preferably a non-ionic surfactant.

By “carrier”, there is meant herein an organic or inorganic material, which can be natural or synthetic, and which is associated with the active ingredient and which facilitates its application to the locus to be treated. This carrier is thus generally inert and should be agriculturally acceptable, especially on the contemplated or treated locus or crop. The carrier can be solid (clay, silicates, silica, resins, wax, fertilizers, etc.) or liquid (water, alcohols, ketones, oil solvents, saturated or unsaturated hydrocarbons, chlorinated hydrocarbons, liquified petroleum gas, etc.).

Among the many additives, the compositions of the invention can comprise surfactants as well as other ingredients such as dispersants, stickers, antifoam agents, antifreezing agents, dyestuffs, thickeners, adhesives, protective colloids, penetrating agents, stabilizing agents, sequestering agents, antiflocculating agents, corrosion inhibitors, pigments and polymers.

More generally, the compositions of the invention can comprise all kinds of solid or liquid additives which are known in the art.

The surfactants can be of the emulsifying or wetting type, ionic or non-ionic. Possible surfactants are salts of polyacrylic or lignosulfonic acids; salts of phenolsulfonic or naphthalenesulfonic acids; polycondensates of ethylene oxide with fatty alcohols or fatty acids or fatty amines or substituted phenols (particularly alkylphenols or arylphenols); ester-salts of sulfosuccinic acids; taurine derivatives, such as alkyl taurates; phosphoric esters; or esters of alcohols or polyoxyethylated phenols. When the spraying vehicle is water, the use of at least one surfactant is generally required because the active ingredient is generally not water-soluble.

The method of application of the compositions of the invention is generally the spraying of a mixture which has been previously made, by dilution of more concentrated formulations according to the invention.

In another aspect of the present invention, application of the composition to the tree is preferably made after the fruit has set, that is after flowers have been pollinated and fruit has formed on the tree. The application is preferably made when the fruit is from 2 to 6 cm in diameter, preferably from 3 to 5 cm in diameter.

According to the present invention, it has been surprisingly found that the amount of fruit drop generally decreases as a function of the amount of cyclanilide applied. In general, cyclanilide is applied at a rate from 5 to 500 g/ha, preferably from 10 to 200 g/ha, more preferably from 20 to 100 g/ha, most preferably from 25 to 50 g/ha.

The present invention also relates to a method of improving the quality of apples, which method comprises applying a composition comprising cyclanilide to the trees on which the apples grow.

It has been surprisingly found that apples treated by the method of the invention have a lower starch content than apples not treated by the method of the invention. Preferably, the apples have a starch index of from 4.5 to 5 at harvest. The starch index is indicative of the ability of the fruit to be stored over a long period of time. The lower the number means that there is a lower amount of starch, and thus a better quality fruit.

It also has been surprisingly found that apples treated by the method of the invention have a higher content of soluble solids than untreated fruit and than fruit treated by prior art compounds as measured by the BRIX index. Generally, the amount of soluble solids is from 12.8 to 13 as measured in a BRIX test. In general, a higher soluble solids measurement indicates an increase in the sweetness of the fruit.

It also has been surprisingly found that apples treated by the method of the invention generally have a greater firmness than untreated fruit and than fruit treated by prior art compounds.

The invention also provides a method of delaying fruit maturity in apples which method comprises applying a composition comprising cyclanilide to the trees on which the fruit grow. However, it has been surprisingly found that apples treated by the method of the invention generally have a better color characteristic than fruit treated by prior art compounds. Thus, the method of the invention provides an improvement to the art of storage of fruit.

The following Examples provide non-limiting illustrations of the invention.

### EXAMPLE 1

An orchard of McIntosh® Apple trees at a stage where the apples were approximately 4.5 cm in diameter were sprayed with an aqueous suspension comprising cyclanilide and Regulaid®, a non-ionic surfactant (0.25% v/v) at several rates. About two months later, the following observations were made:

| Rate of | | % fruit | | BRIX index |
|---|---|---|---|---|
| cyclanilide | | dropped | Fruit Starch | (soluble |
| (g/ha) | | from tree | Index | solids) |
| 0 | (Regulaid ®) only | 53.0 | 5.8 | 12.4 |
| 50 | 6 | 5.1 | 13 | |
| 100 | 9.8 | 5.0 | 12.9 | |
| 200 | 13.5 | 4.9 | 13.0 | |

### EXAMPLE 2

The process of Example 1 was repeated using an aqueous suspension comprising cyclanilide and a surfactant using an application rate of cyclanilide of 50 g/ha. As a comparison, ReTain® ([S]-trans-2-amino-4-(2-aminoethoxy)-3-butenoic acid) was applied according to commercially acceptable methods on another plot of trees and another plot of trees were left untreated.

Just before harvest, the following results were obtained:

| | | % cumulative | |
|---|---|---|---|
| | | fruit dropped | Fruit Starch |
| g/ha of ingredient | | from tree | Index |
| 0 | (Untreated) | 62.1 | 5.8 |
| 50 | Cyclanilide | 47.4 | 5.0 |
| 125 | ReTain ® | 68.2 | 5.4 |

The overall quality of fruit obtained after treatment with cyclanilide was better than that of the untreated fruit and that obtained from treatment by the prior art compound ReTain®. The color of the fruit obtained after treatment with cyclanilide was better than that of the fruit treated by the prior art compound ReTain®.

What is claimed is:

1. A method of improving the quality of apples, said method comprising applying a composition comprising cyclanilide, in an amount effective to improve apple quality, and an agriculturally acceptable carrier therefor to a tree on which the apples grow.

2. A method of preventing premature fruit loss from a tree on which apples grow, said method comprising applying a composition comprising cyclanilide, in an amount effective to prevent premature fruit loss, and an agriculturally acceptable carrier therefor to the tree.

3. A method of delaying fruit maturity in apples, said method comprising applying a composition comprising cyclanilide, in an amount effective to delay fruit maturity, and an agriculturally acceptable carrier therefor to a tree on which the apples grow.

4. The method according to claim 1, wherein the composition is applied after the fruit has set.

5. The method according to claim 2, wherein the composition is applied after the fruit has set.

6. The method according to claim 3, wherein the composition is applied after the fruit has set.

7. The method according to claim 1, wherein the composition is applied by spraying the leaves of the tree.

8. The method according to claim 2, wherein the composition is applied by spraying the leaves of the tree.

9. The method according to claim 3, wherein the composition is applied by spraying the leaves of the tree.

10. The method according to claim 4, wherein the composition is applied by spraying the leaves of the tree.

11. The method according to claim 5, wherein the composition is applied by spraying the leaves of the tree.

12. The method according to claim 6, wherein the composition is applied by spraying the leaves of the tree.

13. The method according to claim 1, wherein the composition is applied by spraying the fruit.

14. The method according to claim 2, wherein the composition is applied by spraying the fruit.

15. The method according to claim 3, wherein the composition is applied by spraying the fruit.

16. The method according to claim 4, wherein the composition is applied by spraying the fruit.

17. The method according to claim 5, wherein the composition is applied by spraying the fruit.

18. The method according to claim 6, wherein the composition is applied by spraying the fruit.

19. The method according to claim 7, wherein the composition is applied by spraying the fruit.

20. The method according to claim 8, wherein the composition is applied by spraying the fruit.

21. The method according to claim 9, wherein the composition is applied by spraying the fruit.

22. The method according to claim 10, wherein the composition is applied by spraying the fruit.

23. The method according to claim 11, wherein the composition is applied by spraying the fruit.

24. The method according to claim 12, wherein the composition is applied by spraying the fruit.

25. The method according to claim 4, wherein the composition is applied by spraying when the fruit is from 2 to 6 cm in diameter.

26. The method according to claim 5, wherein the composition is applied by spraying when the fruit is from 2 to 6 cm in diameter.

27. The method according to claim 6, wherein the composition is applied by spraying when the fruit is from 2 to 6 cm in diameter.

28. The method according to claim 25, wherein the composition is applied by spraying when the fruit is from 3 to 5 cm in diameter.

29. The method according to claim 26, wherein the composition is applied by spraying when the fruit is from 3 to 5 cm in diameter.

30. The method according to claim 27, wherein the composition is applied by spraying when the fruit is from 3 to 5 cm in diameter.

31. The method according to claim 1, wherein the composition is in aqueous form.

32. The method according to claim 2, wherein the composition is in aqueous form.

33. The method according to claim 3, wherein the composition is in aqueous form.

34. The method according to claim 1, wherein cyclanilide is applied at a rate from 5 to 500 g/ha.

35. The method according to claim 2, wherein the cyclanilide is applied at a rate of from 5 to 500 g/ha.

36. The method according to claim 3, wherein the cyclanilide is applied at a rate of from 5 to 500 g/ha.

37. The method according to claim 34, wherein the cyclanilide is applied at a rate of from 10 to 200 g/ha.

38. The method according to claim 35, wherein the cyclanilide is applied at a rate of from 10 to 200 g/ha.

39. The method according to claim 36, wherein the cyclanilide is applied at a rate of from 10 to 200 g/ha.

40. The method according to claim 37, wherein the cyclanilide is applied at a rate of from 20 to 100 g/ha.

41. The method according to claim 38, wherein the cyclanilide is applied at a rate of from 20 to 100 g/ha.

42. The method according to claim 39, wherein the cyclanilide is applied at a rate of from 20 to 100 g/ha.

43. The method according to claim 40, wherein the cyclanilide is applied at a rate of from 25 to 50 g/ha.

44. The method according to claim 41, wherein the cyclanilide is applied at a rate of from 25 to 50 g/ha.

45. The method according to claim 42, wherein the cyclanilide is applied at a rate of from 25 to 50 g/ha.

46. The method according to claim 1, wherein the starch content of the apples is reduced.

47. The method according to claim 46, wherein the starch index of the apples at harvest is from 4.5 to 5.

48. The method according to claim 1, wherein the amount of soluble solids in the apples at harvest is from 12.8 to 13 as measured in a Brix test.

49. A method of improving the quality of apples, said method comprising applying a composition comprising cyclanilide, in an amount effective to improve apple quality, and an agriculturally acceptable carrier therefor, to a tree on which apples in need of such improvement grow, said composition being applied by spraying the leaves or fruit of the tree after the fruit has set, when the fruit is from 3 to 5 cm in diameter, the cyclanilide being applied at a rate of from about 50 to about 100 g/ha, said method affording apples having a starch index at harvest of from 4.5 to 5 and a BRIX index of soluble solids at harvest of 12.8 to 13.

50. A method of preventing premature fruit loss from a tree on which apples grow which is in need of such prevention, said method comprising applying a composition comprising cyclanilide, in an amount effective to prevent premature fruit loss, and an agriculturally acceptable carrier therefor, to said tree, said composition being applied by spraying the leaves or fruit of the tree after the fruit has set, when the fruit is from 3 to 5 cm in diameter, the cyclanilide being applied at a rate of from about 50 to about 100 g/ha.

51. A method of delaying fruit maturity in apples, said method comprising applying a composition comprising cyclanilide, in an amount effective to delay fruit maturity, and an agriculturally acceptable carrier therefor, to a tree on which apples grow which is in need of such delay, said composition being applied by spraying the leaves or fruit of the tree after the fruit has set, when the fruit is from 3 to 5 cm in diameter, the cyclanilide being applied at a rate of from about 50 to about 100 g/ha.

52. A method of preventing premature fruit loss from a tree on which apples grow which is in need of such prevention while improving the quality of said apples, said method comprising applying a composition comprising cyclanilide, in an amount effective to prevent premature fruit loss which is also effective to improve the quality of said apples, and an agriculturally acceptable carrier therefor, to said tree, said composition being applied by spraying the leaves or fruit of the tree after the fruit has set, when the fruit is from 3 to 5 cm in diameter, the cyclanilide being applied at a rate of from about 50 to about 100 g/ha, said method affording apples having a starch index at harvest of from 4.5 to 5 and a BRIX index of soluble solids at harvest of 12.8 to 13.
